(19) United States
(12) Patent Application Publication
(10) Pub. No.: US 2016/0335444 A1
(43) Pub. Date: Nov. 17, 2016

(54) Proximity based digital rights management method and system

(71) Applicants: Jari Kiuru, Luhalahti (FI); Antti Kosunen, Helsinki (FI)

(72) Inventors: Jari Kiuru, Luhalahti (FI); Antti Kosunen, Helsinki (FI)

(21) Appl. No.: 15/109,171

(22) PCT Filed: Dec. 5, 2014
(86) PCT No.: PCT/FI2014/050959

§ 371 Date: Jun. 30, 2016

(30) Foreign Application Priority Data
Dec. 27, 2013 (FI) 20136331

(51) Int. Cl. G06F 21/62; H04W 4/02

(52) U.S. Cl. CPC G06F 21/6209; H04W 4/025; G06F 2221/2111

(57) ABSTRACT

According to an example embodiment of the present invention, there is provided a method of controlling digital user rights on a mobile device comprising the computer implemented steps of running an application having a first set of digital user rights on a mobile device, wherein the first set of digital user rights have predetermined activation criteria associated therewith, obtaining, by the mobile device, proximity data about the proximity of at least one secondary device, determining, based on at least the obtained proximity data and the predetermined activation criteria, a digital user right to be activated, and activating the determined digital user right.

### FIELD OF INVENTION

The present invention relates to proximity-based processing and management of digital rights.

### BACKGROUND OF INVENTION

Content items such as music, literature, journalism, movies and art may be associated with rights, which may include trademarks and copyrights. Other content items, such as process control programs, may be associated with user rights that govern who can use the items to modify parameters of associated processes.

In connection with digital media items and/or digital programs, rights may be referred to as digital rights. When digital rights relate to a user or users, they may be referred to as digital user rights. Digital user rights may be associated with, for example, digitally stored music of films and used to govern under which circumstances a user, and which user, may be granted access to the music or films, respectively.

A user who purchases a digital content item may purchase a restricted right to access the digital content. For example, digital user rights attached to the digital content may be configured to allow the purchasing user to only store the digital content on one device. Alternatively or additionally, digital user rights may restrict a number of times the user may access the digital content. For example, a song may be configured to be listened to only five times, after which the use rights will have been exhausted.

Digital user rights may be arranged in accordance with a standard in digital rights management, for example wherein a digital content item and a media playing device may be arranged to interoperate so that the media playing device will enforce the digital user rights associated with the digital content item. A description of the digital user rights may be attached to or included in a digital file comprising the digital content item.

A description of digital user rights associated with a digital content item may be arranged in a digital file in a way that makes its removal by a user more difficult. For example, the digital file may comprise a digital hash and digital signature, whereby should a user remove the description of the digital user rights, the hash and signature would no longer match the resulting file and playback of the content could be denied by the media playing device.

### SUMMARY OF THE INVENTION

According to a first aspect of the present invention, there is provided a method of controlling digital user rights on a mobile device comprising the computer implemented steps of running an application having a first set of digital user rights on a mobile device, wherein the first set of digital user rights have predetermined activation criteria associated therewith obtaining, by the mobile device, proximity data about the proximity of at least one secondary device, determining, based on at least the obtained proximity data and the predetermined activation criteria, a digital user right to be activated, and activating the determined digital user right.

According to at least some variants of the first aspect, no server running the application is involved in the determination of a digital user right to be activated.

According to at least some variants of the first aspect, no server running the application is involved in the activation of the determined digital user right.

According to at least some variants of the first aspect, the digital user right determined by the mobile device to be activated is activated directly on the mobile device. For example, once a determination to activate a digital user right has been made, in these variants no external data is used by the mobile device to activate the digital right.

According to at least some variants of the first aspect the digital user right is activated, by the mobile device, on at least one of the secondary devices. For example, in these variants the method may further comprise generating activation data necessary for the activation of the determined digital user right on at least one secondary device. For example, in these variants the method may further comprise transmitting activation data necessary for the activation of the determined digital user right from the mobile device to at least one of the secondary devices through the application and/or through a wireless means.

According to at least some variants of the first aspect, activating the determined digital user right on the mobile device further comprises receiving activation data necessary for the activation of the determined digital user right from at least one of the secondary devices.

According to at least some variants of the first aspect, the at least one secondary device runs a second application having a second set of digital user rights and the first and second sets of digital user rights are the same.

According to at least some variants of the first aspect, the at least one secondary device runs a second application having a second set of digital user rights and the first and second sets of digital user rights are different but share at least one digital user right in common.

According to at least some variants of the first aspect, the at least one secondary device runs a second application and the application running on the mobile device is the same application as the second application of the at least one secondary device.

According to at least some variants of the first aspect, the at least one secondary device runs a second application the application running on the mobile device is a different application from the second application of the at least one secondary device. For example, the second application of the at least one secondary device may be a different version of the application running on the mobile device.

According to a second aspect of the present invention, there is provided a non-transitory computer readable medium having stored thereon a set of computer implementable instructions for controlling a plurality of digital user rights for an application, wherein the plurality of digital user rights have predetermined activation criteria associated therewith, said digital user rights and said application being stored on a mobile device, and said instructions are configured to cause a processor of the mobile device to carry out the steps comprising obtaining, by the mobile device, proximity data about the proximity of at least one secondary device determining, based on at least the obtained proximity data and the predetermined activation criteria, a digital user right to be activated, and activating the determined digital user right.

According to a third aspect of the present invention, there is provided a mobile device comprising a processor, a storage medium having stored thereon an application and a plurality of digital user rights for said application, wherein the plurality of digital user rights have predetermined activation criteria associated therewith, and the application contains computer implementable instructions configured to cause the processor to carry out at least: obtaining proximity data about proximity of at least one secondary device to said mobile device, determining, based on at least the obtained proximity data and the predetermined activation criteria, a digital user right to be activated, and activating the determined digital user right.

According to a fourth aspect of the present invention, there is provided a server comprising memory storing computer implementable instructions and at least one processor, the computer implementable instructions being configured to cause, with the processor, the server to at least process a request received from a mobile device for a right to access at least one of an application and a content item, the digital user rights having predetermined activation criteria associated therewith comprising at least one proximity criterion, determine, based on proximity of at least one secondary device to the mobile device, whether the at least one proximity criterion is satisfied, and based at least in part on a result of the determination, grant or deny access to the at least one of an application and a content item for the mobile device.

According to at least some variants of the fourth aspect, the server is configured to transmit a message to the mobile device, the message comprising an indication of the granting or the denying of the access.

According to a fifth aspect of the present invention, there is provided a method of controlling digital user rights of at least one application on a mobile device having a set of digital user rights, said method comprising the computer implemented steps of detecting the proximity between a plurality of mobile devices, each mobile device running an application having a set of digital user rights, wherein the set of digital user rights of each application have predetermined activation criteria associated therewith, determining, based on at least the detected proximity data and the predetermined activation criteria of at least one of the plurality of mobile devices, a digital user right to be activated for said at least one mobile device, and activating the determined digital user right on said at least one mobile device.

According to the fifth aspect, detecting the proximity between a plurality of devices may comprise obtaining proximity data in at least one of the plurality of mobile devices.

According to the fifth aspect, proximity data may be obtained by deriving it in at least one of the mobile devices from location data exchanged between the mobile devices. Proximity data may be obtained by receiving it in at least one of the mobile devices from a server. The location data may be exchanged between the mobile devices via a server. The location data may be exchanged between the mobile devices via direct device-to-device communication involving only mobile devices.

According to the fifth aspect, at least one digital user right comprised in the set of digital user rights may be at least in part activated upon payment.

### INDUSTRIAL APPLICABILITY

At least some embodiments of the present invention are applicable in managing access rights to software, such as mobile applications. Examples include, but are not limited to, managing user's access to content within and/or features of a software application. At least some embodiments of the present invention are applicable in managing digital user rights relating to the copyright(s) of media and/or artistic content, for example to limit more accurately user access to content protected or protectable by copyright. Additionally, at least some embodiments of the present invention are applicable in managing the digital user rights relating to features of an application, for example to provide a method of more accurately controlling users access to features of interest for an application developer and/or operator.

### BRIEF DESCRIPTION OF THE DRAWINGS

FIG. 1 illustrates a first example system capable of supporting at least some embodiments of the present invention,

FIG. 2 illustrates a second example system capable of supporting at least some embodiments of the present invention,

FIG. 3 illustrates an example apparatus capable of supporting at least some embodiments of the present invention,

FIG. 4 is a signalling diagram illustrating operations in accordance with at least some embodiments of the present invention, and

FIG. 5 is a flowchart illustrating a method in accordance with at least some embodiments of the present invention.

### DETAILED DESCRIPTION OF EXAMPLE EMBODIMENTS

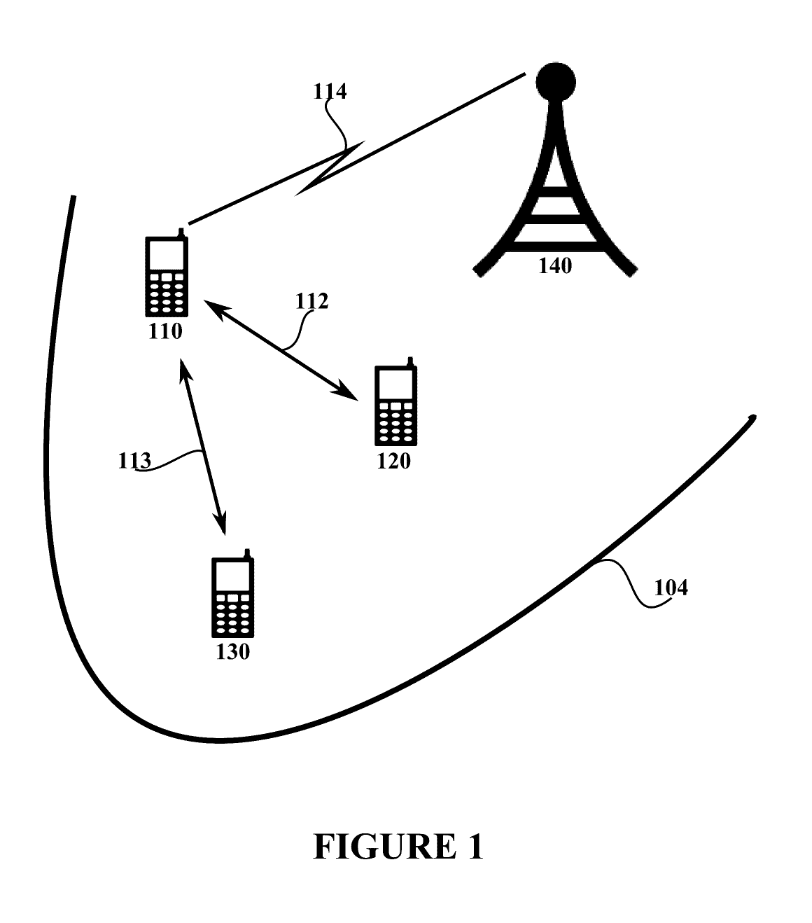

FIG. 1 illustrates a first example system capable of supporting at least some embodiments of the present invention. FIG. 1 illustrates base station 140, which may comprise a cellular or non-cellular base station. A non-cellular base station may be referred to as an access point. Base station 140 may be arranged to operate in accordance with a cellular communication standard, such as for example wideband code division multiple access, WCDMA, or long term evolution, LTE. Base station 140 may be arranged to operate in accordance with a non-cellular communication standard, such as for example wireless local area network, WLAN, also known as Wi-Fi, or worldwide interoperability for microwave access, WiMAX. Base station 140 may be configured to establish wireless links with mobile devices in accordance with any standard or standards base station 140 is arranged to operate in accordance with.

Mobile 110 may comprise a cellular telephone, smartphone, tablet device, phablet device, laptop computer or other electronic device with wired or wireless communication capability. In the illustrated example, mobile 110 has wireless link 114 with base station 140. Wireless link 114 may operate in accordance with a wireless standard that both mobile 110 and base station 140 are configured to support. Wireless link 114 may comprise an uplink for conveying information from mobile 110 to base station 120. Wireless link 114 may comprise a downlink for conveying information from base station 120 to mobile 110. Wireless link 114 may be arranged to operate in accordance with time division multiple access TDMA, or code division multiple access, CDMA, principles, for example.

Mobile 110 may be configured to seek attachment to a cell controlled by base station 120 when disposed inside such a cell. FIG. 1 illustrates a boundary of a cell coverage area of a cell controlled by base station 140 by contour 104. As mobile 110 is disposed inside contour 104, it is within a cell coverage area of a cell controlled by base station 140 and capable of attaching to such a cell.

Responsive to approaching contour 104, mobile 110 may be configured to measure for transmissions from other base stations in anticipation of a possible handover to a cell controlled by such other base station in case mobile 110 leaves the cell coverage area defined by contour 104. Such other base stations may be comprised in the same network as base station 140, or in other networks. Such other base stations may operate in accordance with a same wireless standard as base station 140, or they may operate in accordance with a different standard. A handover to a cell controlled by a base station operating in accordance with a different standard may be referred to as an inter-radio access technology, or inter-RAT, handover.

Mobile 110 may be configured to possess, or obtain, an application or content with associated user rights, such as digital user rights. The digital user rights may be configured to allow access to the application or content conditionally, wherein the condition or conditions may be related to proximity of further devices, wherein the further devices may be mobile or immobile. Further devices may be considered as secondary devices for terminological purposes. In some embodiments, mobile 110 may perform the role of further, or secondary, device with respect to application or content stored on or accessed via a third device.

According to certain embodiments, the method and system described herein is applicable in managing access rights to software. Examples of such software are the applications running on mobile devices, such as on smart phones and tablets. Examples of access rights to software are digital user rights. Digital user rights, as described herein, are capable of granting and/or limiting access to, for example, content or features of a software or application. According to some examples, the method and system are capable of managing digital user rights relating to the access to copyrighted or copyrightable material, such as videos, pictures, music, software code, artistic content.

Additionally, according to some examples, the method and system are applicable in managing the digital user rights relating to features of an application. For example, to provide for more accurately controlling users access to features of interest for an application developer and/or operator. Features of interest can be, for example, features which have value and/or are monetizable. For example, an application may have certain core features which are globally accessible to users but the rights for individual users to access additional and/or auxiliary features can be controlled by the present method. In accordance with embodiments presented herein, these additional and/or auxiliary features can be freely accessible, through the embodiments of the present invention, when criteria as described herein is met, e.g. proximity to a predetermined number of other qualified users/devices. At other times the content may still be accessible but may require some type of compensation, for example in the form of money, digital currency or tokens, in order to access it.

Mobile 110 may obtain the application or content with associated user rights over wireless link 114, for example. Alternatively, mobile 110 may obtain the application or content over another interface, such as for example a Wi-Fi or NFC interface.

The condition related to proximity of further devices may comprise that a user of mobile 110 is granted access to the application or content only in case at least one further device is in proximity of mobile 110. Identities of each of the at least one further device may be comprised in the digital user rights associated with the application or content. Alternatively, the digital user rights may comprise an identity of a list, the list being stored remotely, wherein the condition relating to proximity comprises that a predetermined number of devices the identities of which are comprised in the list must be in proximity of mobile 110 in order for the user of mobile 110 to be given access to the application or content. The digital user rights may comprise an indication of how close a device must be in order to be considered to be in proximity. The digital user rights may comprise an indication of how many of the devices on the list must be in proximity for the user of mobile 110 to be given access. When the list is stored remotely, it may be updated centrally to control access to the application or content for a plurality of mobiles 110.

The digital user rights associated with the application or content may be comprised in the application or content, in other words in at least one digital file that also contains the application or content. Alternatively, the digital user rights may be stored in a server and the application or content may comprise an identity of the digital user rights that mobile 110 can use to obtain the digital user rights from the server. In some embodiments, the digital user rights are stored on a server and the list of identities of further devices is stored remotely, that is not on mobile 110. In these embodiments, mobile 110 is configured to first fetch the digital user rights from the server, and subsequently, based on an identity of the list comprised in the digital user rights, fetch the list from the remote location to obtain the identities of the further devices.

To determine whether a further device is in proximity, mobile 110 may obtain from base station 140 an indication that the further device is in proximity. In this case, a cellular network in which base station 140 is comprised may have determined a current location estimate for the further device, or the network may have received the location estimate from the further device concerned. Alternatively, mobile 110 may obtain directly from the further device an estimate of a current location of the further device, which the further device may have obtained using an integrated satellite positioning circuitry, for example. Mobile 110 may obtain such a location estimate directly using, for example, direct device-to-device communication using a cellular or non-cellular wireless interface. Direct device-to-device communication may comprise communication wherein a further device transmits information encoded in radio waves and mobile 110 receives the radio waves and decodes the information encoded therein without the radio waves being re-transmitted in-between by a base station or any other node.

FIG. 1 illustrates distances between devices as distance 112 and distance 113. Distance 112 separates mobile 110 from further device 120. Further device 120 may comprise a device similar to mobile 110, for example. Distance 113 separates mobile 110 from further device 130. Further device 130 may comprise a device similar to mobile 110, for example. Distance 112 may be determined from geo-locations of mobile 110 and further device 130. For example, distance 112 may be determined in mobile 110 once mobile 110 is aware of its own geolocation and a geolocation of further device 120. Distance 113 may similarly be determined from geo-locations of mobile 110 and further device 130. For example, distance 113 may be determined in mobile 110 once mobile 110 is aware of its own geolocation and a geolocation of further device 130.

Once at least one of distance 112 and distance 113 is determined, its length may be compared to a threshold length to determine if further device 120 or further device 130 is in proximity of mobile 110. The threshold length may be specific to the further device, in other words a first further device may be considered in proximity as defined by a first threshold length and a second further device may be considered in proximity as defined by a second threshold length. Alternatively, threshold lengths for all further devices, in case there are more than one further device specified in the digital user rights, may be the same. In some embodiments, all threshold lengths are defined in the digital user rights, in other words the digital user rights describe how near the at least one further device must be to be in proximity.

Proximity data may be received in mobile 110 or mobile 110 may be configured to derive the proximity data from geolocation data or other positional data, such as for example address data. In this sense, mobile 110 may obtain proximity data by receiving it or by deriving it.

In some embodiments, the application comprises a web browser and a further device comprises a device of a parent. In these embodiments, a web browser on a mobile 110 of a child will only start, or only allow access to certain content, in case the further device of the parent is in proximity, which may be defined as closer than a threshold length of 2, 5 or ten meters, for example. Thus children may be prevented from accessing unsuitable web content in the absence of their parents.

In general, in some embodiments, mobile 110 is configured to transmit periodically query messages to a server to inquire, of digital user rights associated with at least one application and/or content item are activated due to proximity of at least one further device. In such cases the user may be alerted, for example with a suitable audio signal, that digital access rights have been activated and the user may use an application, or access a content item.

As an example, a user of mobile 110 may be in a concert with a plurality of other persons. Content relating to the concert, such as an interactive program guide and/or music, may be defined in associated digital user rights as accessible when the plurality of other persons are substantially in proximity but not otherwise, for example after the concert when the crowd has dispersed. A user may, however, be granted at least limited access to the content relating to the concert in case a subset of the plurality of other persons gathers in proximity once more, for example if a group of friends

As an example, the threshold length defining how close a further device needs to be to be considered to be in proximity may depend on the time of day. For example, the threshold distance may be shorter at night-time than day-time. This may have security implications, as the distance people can see and find each other is shorter at night-time, so the threshold distance may be shorter at night-time than day-time. When roaming in a forest, for example, and listening to music the threshold distance may become progressively shorter when the sun begins to set. In this way, people are caused to be herded closer to each other and, for example, a family kept together.

A user of mobile 110 may be provided with an indication when at least one of the at least one further devices is foreseen to leave proximity, either due to movement or due to shortening of the threshold length pertaining to this further device.

Additional examples include educational software. For example, an educational program loaded on multiple devices can be utilized in a classroom environment amongst a plurality of pupils. When in the classroom environment, and in proximity to the large group of pupils some or all of the content is available through the management of user access rights as described herein. When the pupil is outside of the classroom, such as at home, then some or all of the content can be disabled or accessible only through compensatory means, e.g. payment using tokens, certificates, digital or real currency. Additionally, when the pupil is around a small subset of the class, e.g. in a study group, some portion or all of the content can be accessible. One example use case would be that an application for a course with all of the course material would be distributed to a class full of pupils. During class time, when all or a large portion of the pupils are together then at least material related to lectures would be available to the pupils on their mobile devices. When at home studying, some or all of the lecture material may be blocked. This would incentivize pupils to attend classes. Furthermore, when in a small subset, e.g. in a 2-6 person group, then some group work and/or study session material could be accessible. This would allow a teacher/professor to effectively control and force group work outside of class without actually needing to be physically present. Therefore, the use of digital rights for content/features can be tied to specific criteria including discrete and/or open ended ranges of proximate secondary devices. This can be augmented with other criteria such that, for example, only lecture material related to certain lectures on certain dates is available within each situation, such that a pupil could not skip ahead in lecture. One useful example of this would be that the answers to exams or example problems could be predestributed but only accessible under certain conditions such as after a certain time and within the proximity of X number of individuals. Alternatively, the answers to exams or example problems could be predestributed but only accessible under certain conditions such as after a certain time and when the user is separated from all other users by a predetermined distance.

Another example can be within the field of gaming. One example use case would be wherein when a number of individual users are playing a game together they may have access to special features, e.g. weapons, resources, etc., which can be used individually or collectively against each other within the group or others outside of the group. When not fulfilling the criteria for free use the use may be accessible through some form of compensation, as discussed above. A further example is managing an industrial process, wherein proximity may be used to limit access to programs controlling industrial process parameters to persons accompanied by a qualified person to improve industrial safety.

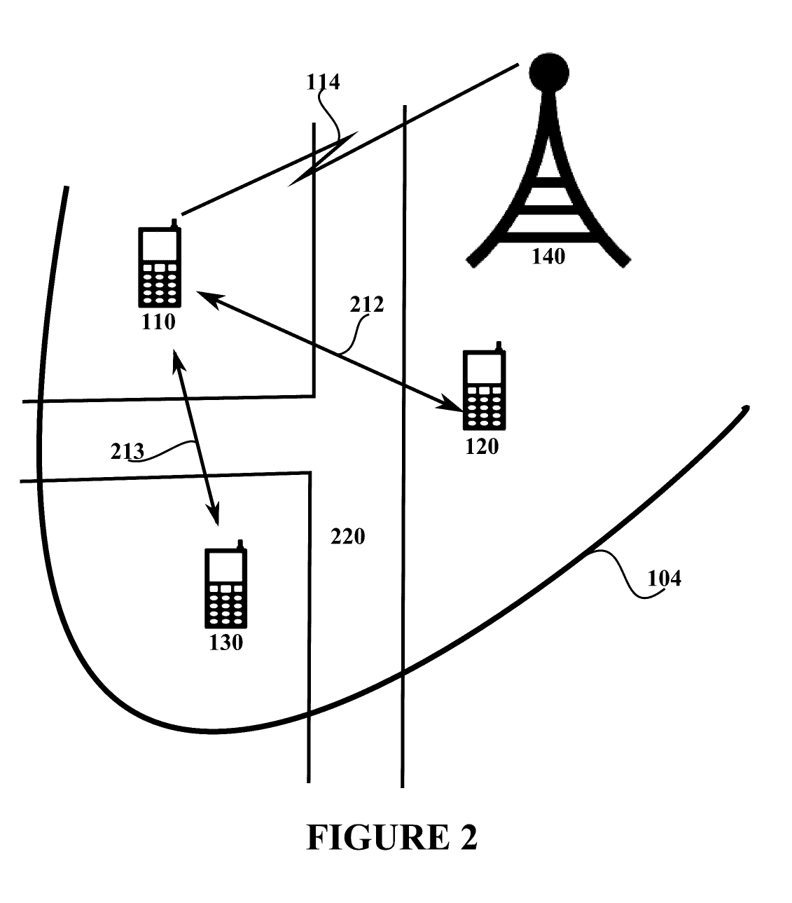

FIG. 2 illustrates a second example system capable of supporting at least some embodiments of the present invention. In FIG. 2, like reference numbers denote like structures when compared to FIG. 1. In detail, mobile 110, further device 120, further device 130, base station 140 and wireless link 114 may be essentially similar to those in FIG. 1. Street 220 is illustrated schematically in FIG. 2.

In FIG. 2, distance 212 between mobile 110 and further device 120 is defined in terms of street address. Similarly, distance 213 between mobile 110 and further device 130 is defined in terms of street address. The digital user rights may define a maximum difference in street address that may separate mobile 110 from the at least one further device, for each of the at least one further device to be considered in proximity.

In FIG. 2, mobile 110 is located in a different building than further device 120 and further device 130. Digital user rights associated with an application or content a user of mobile 110 desires to use or access may be configured to disallow use or access in case at least one further device, such as device 120 or device 130, is not disposed in the same building as mobile 110.

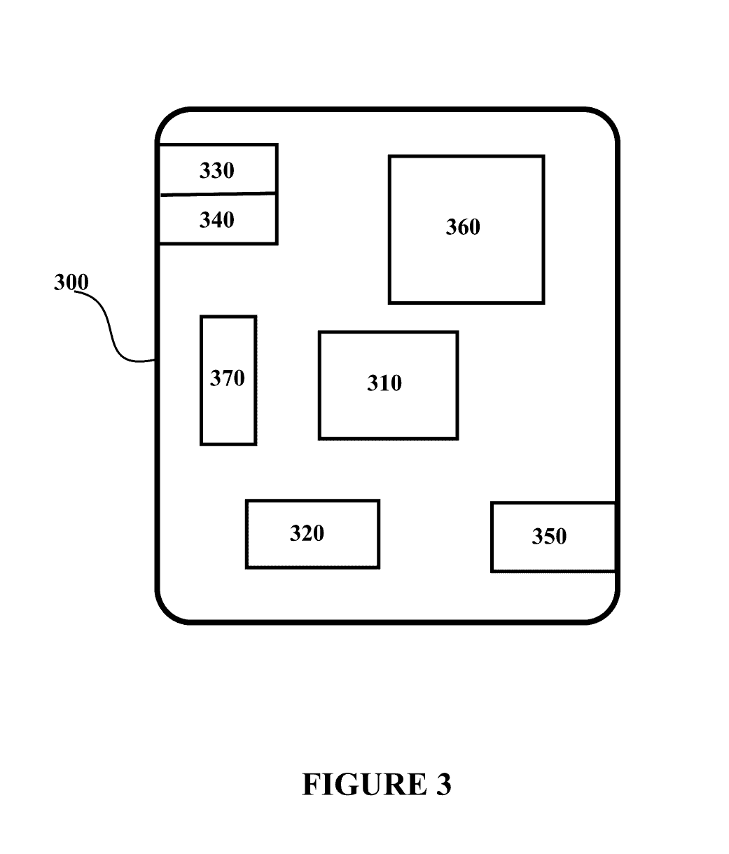

FIG. 3 illustrates an example apparatus capable of supporting at least some embodiments of the present invention. Illustrated is device 300, which may comprise, for example, a mobile communication device such as mobile 110 of FIG. 1. Comprised in device 300 is processor 310, which may comprise, for example, a single- or multi-core processor wherein a single-core processor comprises one processing core and a multi-core processor comprises more than one processing core. Processor 310 may comprise a Qualcomm Snapdragon 800 processor, for example. Processor 310 may comprise more than one processor. A processing core may comprise, for example, a Cortex-A8 processing core manufactured by Intel Corporation or a Brisbane processing core produced by Advanced Micro Devices Corporation. Processor 310 may comprise at least one application-specific integrated circuit, ASIC. Processor 310 may comprise at least one field-programmable gate array, FPGA.

Device 300 may comprise memory 320. Memory 320 may comprise random-access memory and/or permanent memory. Memory 320 may comprise at least one RAM chip. Memory 320 may comprise magnetic, optical and/or holographic memory. Memory 320 may be at least in part accessible to processor 310. Memory 320 may comprise computer instructions that processor 310 is configured to execute.

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with global system for mobile communication, GSM, wideband code division multiple access, WCDMA, long term evolution, LTE, IS-95, wireless local area network, WLAN, and/or worldwide interoperability for microwave access, WiMAX, standards, for example.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to accept incoming telephone calls, to originate telephone calls or video calls, to browse the Internet, to manage digital files stored in memory 320 or on a cloud accessible via transmitter 330 and receiver 340, or via NFC transceiver 350, and/or to play games.

Device 300 may comprise or be arranged to accept a user identity module 370. User identity module 370 may comprise, for example, a subscriber identity module, SIM, card installable in device 300. A user identity module 370 may comprise information identifying a subscription of a user of device 300. A user identity module 370 may comprise cryptographic information usable to verify the identity of a user of device 300 and/or to facilitate encryption of communicated information and billing of the user of device 300 for communication effected via device 300.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, some devices 300 may lack a NFC transceiver 350 and/or user identity module 370.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

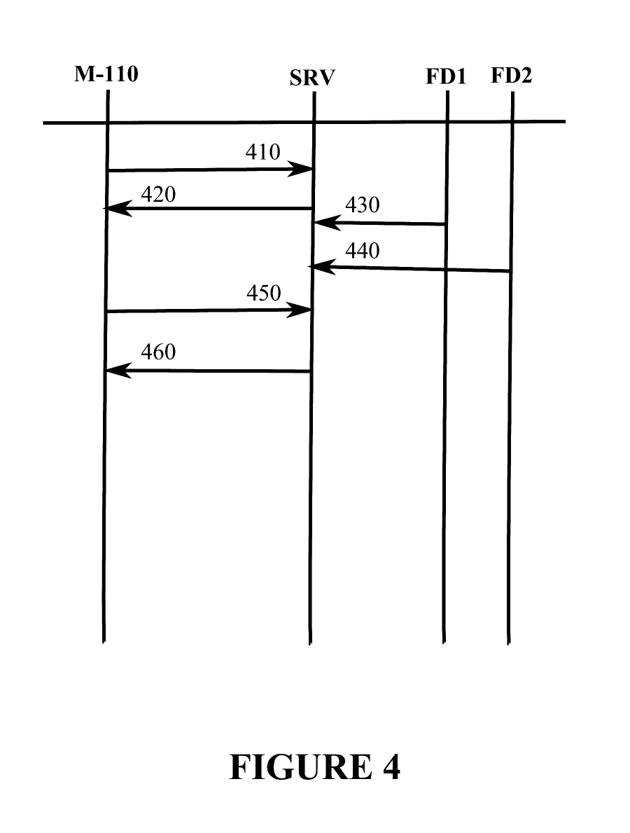

FIG. 4 is a signalling diagram illustrating operations in accordance with at least some embodiments of the present invention. On the vertical axes are disposed, from left to right, mobile 110, denoted as M-110, a server denoted as SRV, a first further device denoted as FD1, and finally a second further device denoted as FD2.

In phase 410, mobile 110 may inquire from the server whether it may use an application stored on mobile 110, or access a content item. The message of phase 410 may comprise an identifier of the application or content item. Such an identifier may comprise a hash value. The message of phase 410 may comprise a copy of digital user rights associated with the application or content item. The message of phase 410 may comprise a pointer to digital user rights associated with the application or content item, wherein the pointer, such as for example a web address or an identity of the digital user rights, enables the server to access a the digital user rights. Mobile 110 may be configured to transmit query messages such as 410 to the server periodically, and in case the server indicates access is granted to alert a user.

In phase 420, the server replies that mobile 110 may not use the application, or access the content item. In the example of FIG. 4, this is since the digital user rights associated with the application or content item define that the first and second further devices must be in proximity of mobile 110 in order for the digital user rights to be activated to grant access to the application or content item. In this example, the server may either not know the whereabouts of at least one of the first and second further device, or it may know that at least one of them is not in proximity.

In phase 430 the server receives a location of the first further device, or an indication from the first device that the first device has determined it is in proximity of mobile 110. In phase 440 the server receives a location of the second further device, or an indication from the second device that the second device has determined it is in proximity of mobile 110.

In phase 450, mobile 110 may transmit a second query message to the server inquiring whether it may use an application stored on mobile 110, or access a content item. Mobile 110 may be configured to transmit the message of phase 450 after a pre-determined time has elapsed from the transmission of phase 410, for example.

In phase 460, the server may reply that mobile 110 may use the application, or access the content item. Since the server has been informed of the locations of the first and second further device, or indeed their proximities to mobile 110, the server is enabled to determine that at least one proximity condition comprised in the digital user rights associated with the application or content item is fulfilled, and that the digital user rights may in this aspect be activated. The message of phase 460 may comprise a decryption key, or other cryptographic information, to enable mobile 110 to process the application or content item.

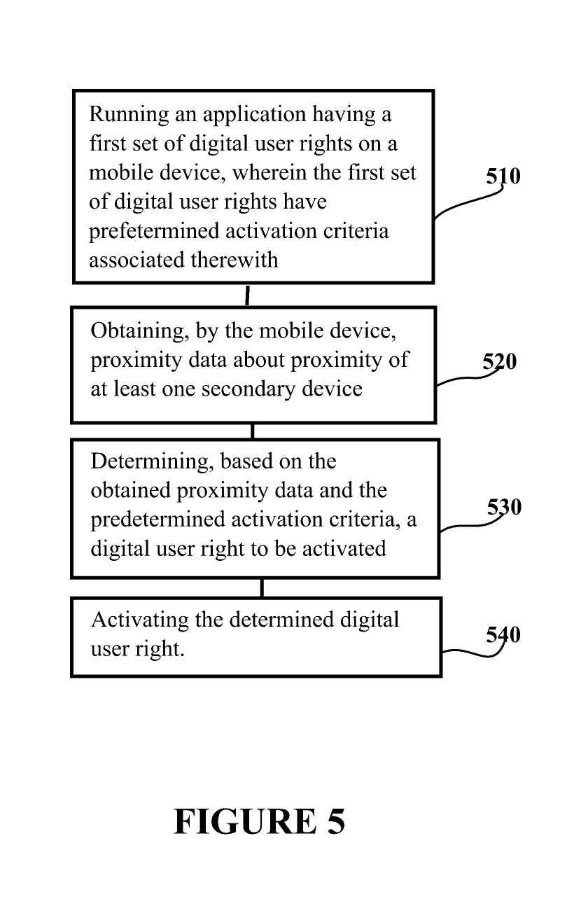

FIG. 5 is a flowchart illustrating a method in accordance with at least some embodiments of the present invention. The phases of the illustrated method may be performed in mobile 110, for example. Phase 510 comprises running an application having a first set of digital user rights on a mobile device, wherein the first set of digital user rights have predetermined activation criteria associated therewith. Phase 520 comprises obtaining, by the mobile device, proximity data about the proximity of at least one secondary device. Phase 530 comprises determining, based on at least the obtained proximity data and the predetermined activation criteria, a digital user right to be activated. Finally, phase 540 comprises activating the determined digital user right.

In general there is provided a method, comprising running an application having a first set of digital user rights on a mobile device, wherein the first set of digital user rights have predetermined activation criteria associated therewith, and obtaining, by the mobile device, proximity data about the proximity of at least one secondary device. The secondary device may be running a second application having a second set of digital user rights. The method further comprises determining, based on at least the obtained proximity data and the predetermined activation criteria, a digital user right to be activated, and activating the determined digital user right. The activating may be partial activating in the sense that the digital user rights comprise at least one non-proximity condition that must be valid simultaneously with the proximity condition for full activation of the user rights. Such a non-proximity condition may be a time period condition, for example, wherein the digital user rights expire permanently after a set time or date.

The predetermined activation criteria associated with each digital user right may include a necessary predetermined number of secondary devices running the application within a predetermined area in order for activation of the digital user right. The activation criteria may comprise identities of each of the predetermined number of secondary devices.

The predetermined area may be a variable radius around the mobile device which varies based on a parameter selected from the group of: time of day, a number of detectable proximate secondary devices, number of active secondary devices running the application, currently activated digital user rights on the mobile device, a history of past digital user rights activated on the mobile device, a type of mobile device, a type of detectable secondary devices, an achievement of a user within the application or a combination thereof. For example, in case a large number of proximate secondary devices are running the application, the radius may be shorter. In case there are more activated digital user rights on the mobile device, the radius may be shorter. In case the user of the mobile device has a history of using many digital user rights, the radius may be shorter. In case the mobile device is a high-end model or is associated with a premium subscription, the radius may be longer.

The mobile device may be configured to provide an estimate of its present location to a server or to a further device. In detail, the proximity of the mobile device may be specified as an activation criterion in digital user rights relating to an application or content item stored in the further device. A further device may request from the mobile device an estimate of the current position of the mobile device. The mobile device may likewise request from at least one further device an estimate of their current position. Any requested position may be responsively provided or, at the option of a user, declined either with a response or by ignoring the request.

Activating the determined digital user right on the mobile device may further comprises receiving activation data necessary for the activation of the determined digital user right from at least one of the secondary devices. Such activation data may comprise cryptographic information such as a decryption key, for example. In some embodiments, the activation data is received from a server or from at least one of the secondary devices via a server. In some embodiments, the activation data is received from at least one of the secondary devices via a direct device-to-device communication.

There is provided a second method, of controlling digital user rights of at least one application on a mobile device having a set of digital user rights, said method comprising the computer implemented steps of detecting the proximity between a plurality of mobile devices, each mobile device running an application having a set of digital user rights, wherein the set of digital user rights of each application have predetermined activation criteria associated therewith determining, based on at least the detected proximity data and the predetermined activation criteria of at least one of the plurality of mobile devices, a digital user right to be activated for said at least one mobile device, and activating the determined digital user right on said at least one mobile device. 31

In a first variant of the second method detecting the proximity between a plurality of devices comprises obtaining proximity data in at least one of the plurality of mobile devices.

In a first version of the first variant of the second method proximity data is obtained by deriving it in at least one of the mobile devices from location data exchanged between the mobile devices.

In a second version of the first variant of the second method proximity data is obtained by receiving it in at least one of the mobile devices from a server.

In a first specific embodiment of the first version of the first variant of the second method the location data is exchanged between the mobile devices via a server.

In a second specific embodiment of the first version of the first variant of the second method the location data is exchanged between the mobile devices via direct device-to-device communication involving only mobile devices.

In a second variant of the second method at least one digital user right comprised in the set of digital user rights is at least in part activated upon payment.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A method of controlling digital user rights on a mobile device comprising the computer implemented steps of:
running an application having a first set of digital user rights on a mobile device, wherein the first set of digital user rights have predetermined activation criteria associated therewith,
obtaining, by the mobile device, proximity data about the proximity of at least one secondary device,
determining, based on at least the obtained proximity data and the predetermined activation criteria, a digital user right to be activated, and
activating the determined digital user right.

2. The method according to claim 1, wherein the predetermined activation criteria of each digital user right is stored directly on the mobile device.

3. The method according to claim 1, wherein the predetermined activation criteria associated with each digital user right includes a necessary predetermined number of secondary devices running the application within a predetermined area in order for activation of the digital user right.

4. The method according to claim 3, wherein the predetermined area is a fixed radius around the mobile device or a fixed radius around one or more of the secondary devices.

5. The method according to claim 3, wherein the predetermined area is a variable radius around the mobile device which varies based on a parameter selected from the group of: time of day, number of detectable proximate secondary devices, number of active secondary devices running the application, currently activated digital user rights on the mobile device, a history of past digital user rights activated on the mobile device, a type of mobile device, a type of subscription on the mobile device, a type of detectable secondary devices, an achievement of a user within the application or a combination thereof.

6. The method according to claim 1, wherein the plurality of digital user rights further comprise a deactivation criteria associated therewith, wherein the deactivation criteria is a predetermined length of time, a predetermined user action or a determination that the original activation criteria is no longer met.

7. The method according to claim 6, further comprising:
determining, by the mobile device, if a deactivation criteria of an active digital user right is met, and
deactivating the determined digital user right.

8. The method according to claim 1, wherein obtaining proximity data by the mobile device includes an active determination, by the mobile device, of the actual or relative location of the at least one secondary device with respect to the mobile device.

9. The method according to claim 1, wherein obtaining proximity data by the mobile device includes receiving data, through the application, from at least one secondary device running the application of its current and/or past location(s).

10. The method according to claim 1, wherein obtaining proximity data by the mobile device includes receiving data, through the application, from at least one secondary device running the application of at least one further secondary device's current and/or past location(s).

11. The method according to claim 1, wherein no server running the application is involved in transmission or reception of proximity data.

12. A non-transitory computer readable medium having stored thereon a set of computer implementable instructions for controlling a plurality of digital user rights for an application, wherein the plurality of digital user rights have predetermined activation criteria associated therewith, said digital user rights and said application being stored on a mobile device, and said instructions are configured to cause a processor of the mobile device to carry out the steps comprising:
obtaining, by the mobile device, proximity data about the proximity of at least one secondary device,
determining, based on at least the obtained proximity data and the predetermined activation criteria, a digital user right to be activated, and
activating the determined digital user right.

13. The non-transitory computer-readable medium according to claim 12, wherein said set of computer implementable instructions are configured to cause the processor of the mobile device to perform a method of controlling digital user rights on a mobile device, the method comprising the computer implemented steps of:
running an application having a first set of digital user rights on a mobile device, wherein the first set of digital user rights have predetermined activation criteria associated therewith,
obtaining, by the mobile device, proximity data about the proximity of at least one secondary device,
determining, based on at least the obtained proximity data and the predetermined activation criteria, a digital user right to be activated, and
activating the determined digital user right.

14. A mobile device comprising:
a processor
a storage medium having stored thereon an application and a plurality of digital user rights for said application, wherein the plurality of digital user rights have predetermined activation criteria associated therewith, and
the application contains computer implementable instructions configured to cause the processor to carry out at least: obtaining proximity data about proximity of at least one secondary device to said mobile device, determining, based on at least the obtained proximity data and the predetermined activation criteria, a digital user right to be activated, and activating the determined digital user right.

15. The mobile device according to claim 14, wherein the computer implementable instructions are configured to cause the processor to carry out a method of controlling digital user rights on a mobile device, the method comprising the computer implemented steps of:
running an application having a first set of digital user rights on a mobile device, wherein the first set of digital user rights have predetermined activation criteria associated therewith,
obtaining, by the mobile device, proximity data about the proximity of at least one secondary device,
determining, based on at least the obtained proximity data and the predetermined activation criteria, a digital user right to be activated, and
activating the determined digital user right.
